(19) United States
(12) Patent Application Publication
(10) Pub. No.: US 2007/0039199 A1
(43) Pub. Date: Feb. 22, 2007

(54) Body and shower dryer combination

(76) Inventor: Allen R. Whitman, Lewisville, TX (US)

Correspondence Address: John E. Vandigriff, 906 Stone Circle Ln, Lewisville, TX, 75056, US

(21) Appl. No.: 11/208,203

(22) Filed: Aug. 22, 2005

(51) Int. Cl. F26B 19/00; F26B 25/06

(52) U.S. Cl. 34/443; 34/229

(57) ABSTRACT

A blower/vacuum apparatus is attached over an existing body shower compartment, or may be constructed in combination with a shower being constructed. The apparatus of the invention is mounted over a shower and provides for directing a flow of air, which may be heated, into the shower compartment. The air stream may be reversed to withdraw air and moisture from the shower compartment. A retractable hose device extends into the shower compartment to which may be attached several devices, including, but not limited to brushes, squeegees, and other devices for use in cleaning the body and the shower compartment.

### FIELD OF THE INVENTION

The invention relates to body showers, and more particularly to a shower which includes bathing and drying apparatus, and attachments for use with them.

### BACKGROUND OF THE INVENTION

Showers and body dryers have been found in the prior art as separate units, but not in combination. Each unit shower or body blower is specifically designed for a specific purpose.

The following patents are given as background of the prior art.

U.S. Pat. 4,685,222, illustrates a drying device which has a blower, a motor for driving the blower, a switch for actuating the blower motor unit, and the heating elements in the duct supplying the blower. The air supplied is received by an air towel having an open upper edge, a back wall, a front wall, and tapering side walls. Air exits the air towel from a slot disposed in the front wall of the enclosure member.

U.S. Pat. 4,724,553, is directed to an apparatus for carrying out a continuous wrapping hydromassage over the whole body of a person only in one direction—of the type comprising, in a shower cabin, means rotating about an axis substantially coinciding with that of the body to be massaged, ejecting at least one water spout distributed according to a cylindrical helix having the same axis—said rotating means consist of a plurality of arc-shaped tube sections provided with nozzles ejecting a flat and divergent spout, the tube sections being supported in a horizontal or inclined position by a straight vertical tube feeding side nozzles and being mounted and guided so as to rotate about said axis.

U.S. Pat. 4,871,900, shows a hot air dryer suspended from the ceiling which may be raised or lowered from the ceiling to surround the user a blow dryer with a drying current of warm air utilizing a flexible skirt which forms a cylinder surrounding the user when lowered, the skirt having interior chambers with one or more interior slots allowing air to escape into the interior of the cylinder.

U.S. Pat. 6,829,841, describes a drying cabinet as used to dry a person's body after bathing or showering. The drying cabinet includes a plurality of adjustable air-dispensing nozzles on two sides and on the rear wall of the cabinet. The nozzles are fluidically connected to each other and to a source of hot dry air by manifolds.

### SUMMARY OF THE INVENTION

The invention is a blower/vacuum apparatus attached over an existing body shower compartment, or may be constructed in combination with a shower being constructed. The apparatus of the invention is mounted over a shower and provides for directing a flow of air, which may be heated, into the shower compartment. The air stream may be reversed to withdraw air and moisture from the shower compartment. A hose device extends into the shower compartment to which may be attached several devices, including, but not limited to brushes, squeegees, and other devices for use in cleaning the body and the shower compartment.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 show the blower/vacuum apparatus mounted over a shower compartment;

FIGS. 2a and 2b shows a brush device for use with the blower/vacuum apparatus;

FIGS. 3a and 3b shows a valve for use for controlling the air flow into and out of the shower;

FIGS. 4a and 4b illustrate a squeegee device for use with the blower/vacuum apparatus; and FIGS. 5a and 5b show a brush device for use with the blower/vacuum apparatus.

FIG. 6 shows an air gun device for blowing air to help dry the shower wall.

### DESCRIPTION OF A PREFERRED EMBODIMENT

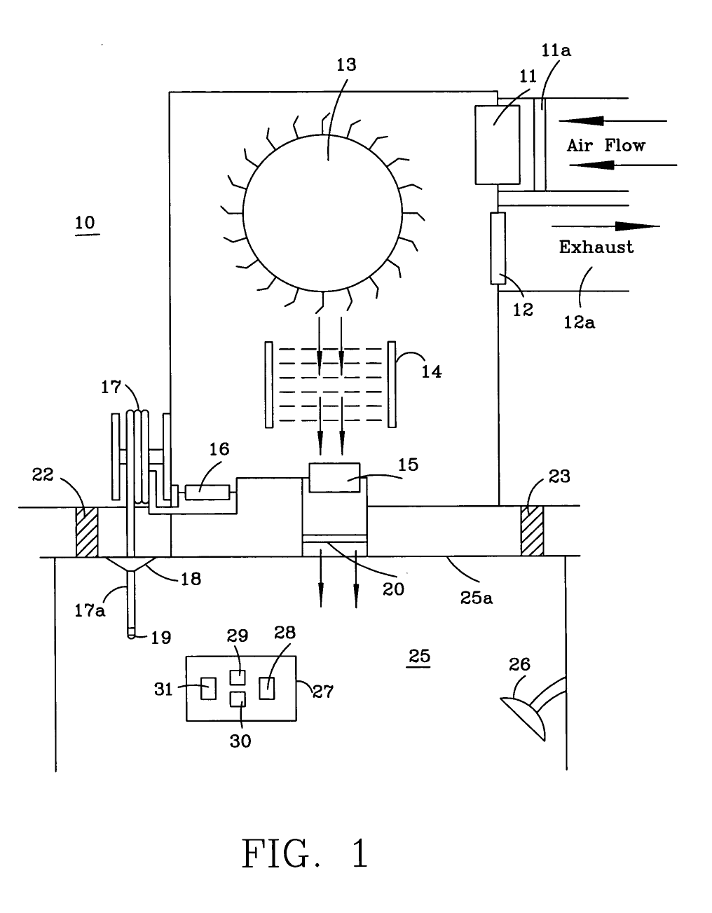

FIG. 1 shows a blower/vacuum apparatus 10 mounted over the ceiling 25a of shower compartment 25, with shower head 26. Blower/vacuum apparatus 10 directs air into shower compartment 25, or provides a vacuum to draw air or moisture out of shower 25. A high velocity fan and motor 13 is used to provide an air flow into shower 25, or withdraw air. Fan 13 is reversible, and direction is controlled by switch 28 on control panel 27. On/Off switch 31 is used to turn fan 13 on or off. When fan 13 is in the blowing mode, air is drawn in through air intake valve 11, and filter screen 11a) unless reverse switch 28 is activated. A valve 16 is used to control the air flow to retractable hose unit 17 and hose 17a. Valve 16 is normally closed and valve 15 is normally open.

When fan 13 is in the exhaust mode, then air/moisture is exhausted through exhaust valve 12, and exhaust hose 12a which is directed to the outside of the structure in which the shower is constructed.

Blower/vacuum apparatus 10 has a heating element 14 which is used to heat the air directed into the shower 25 through control valve 15 and screened vent 20.

Attached to blower/vacuum apparatus 10 is a retractable hose unit 17 which extends a hose 17a into the shower 25, and is connected to control valve 16. Hose 17a has an adjustable stop 18 which controls the length of the hose in shower 25 when it is not being used, and also provides a seal with the top of shower 25. Hose 17a has a quick release nozzle 19 to which may be attached various tools as described below. When hose 17a is in a retracted position, valve 15 is open. This is the normal position. When hose 17a is pulled downward in an extend position, then valve 15 is closed directing air (or vacuum through hose 17a).

Mounted in shower 25 are switches 27 which control various functions. Switch 31 is the on/off switch for blower 13. Switches 29 and 30 control the amount of heat produced by heater 14. Switch 29 is the low heat switch. Switch 30 is the high heat button. Switch 28 is in one position controls fan 13 to direct air into shower 25 at an elevated speed, and in a second position reverses fan 13 at a lower speed drawing air out of shower 25.

As illustrated, blower/vacuum apparatus 10 is mounted on joists 22 and 23 and over ceiling 25a of shower 25. Two openings are required. One for vent and control valve 15. Another opening is required for hose 17a.

FIG, 2a shows the top view of an air brush 40, that has a handle 41, with a quick connected end 42. The end opposite quick connected end 42 is a blower housing 43 that has an air outlet 46. A rotating air motor 44 is rotatably connected to an axle 45. Air is directed though air flow channel 47. When air is directed through brush 40, it will cause air motor 44 to rotate.

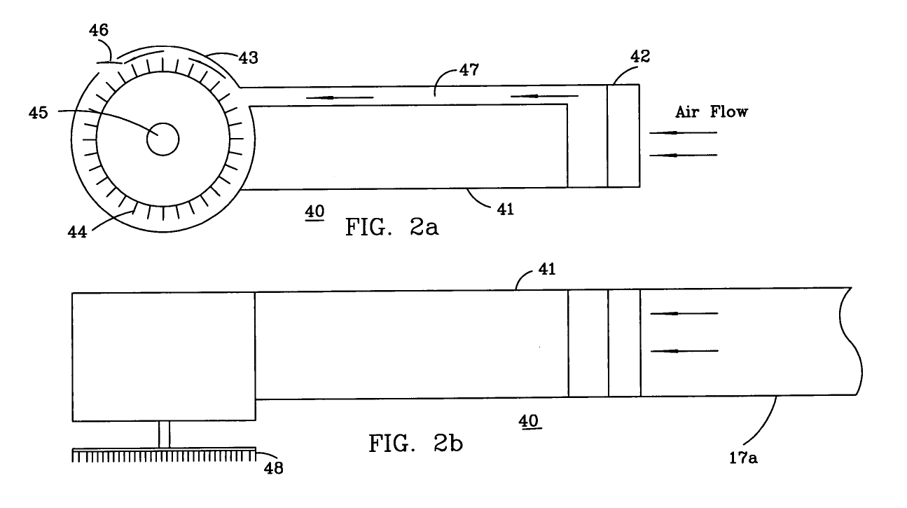

FIG. 2b is a side view of air brush 40. In FIG. 2b, the quick connected end 42 is connected to retractable hose 17a. When air is directed though hose 17a and air flow channel 47 in handle 41, air will turn air motor 44, rotating brush 48 connected thereto. Air brush 40 may be used to clean a person's body. Another similar brush may be used to clean the walls of the shower, and a much smaller version of brush 40 may be used as a toothbrush.

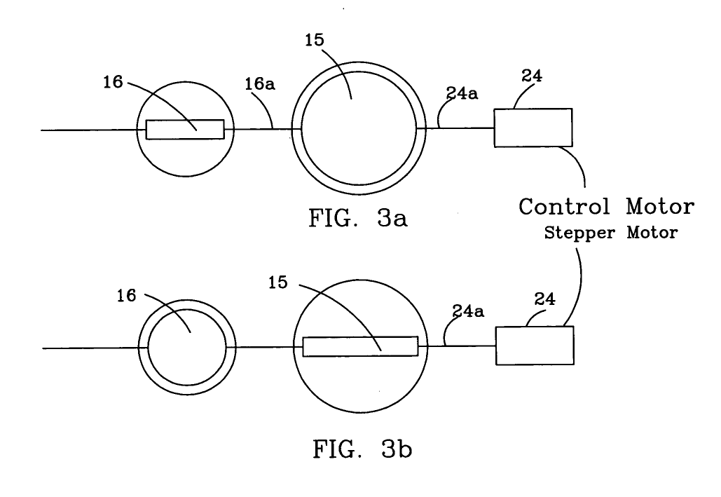

FIGS. 3a and 3b show valves 15 and 16, and control motor 24 used for controlling the air flow into and out of the shower 25. FIG. 3a shows valve 15 in a closed position, and valve 16 is in an open position. Valve 15 is connected to valve 16 by shaft 24a. Both valves 15 and 16 cannot be both opened or closed at the same time. Control motor is a stepper motor for opening and closing valves 15 and 16.

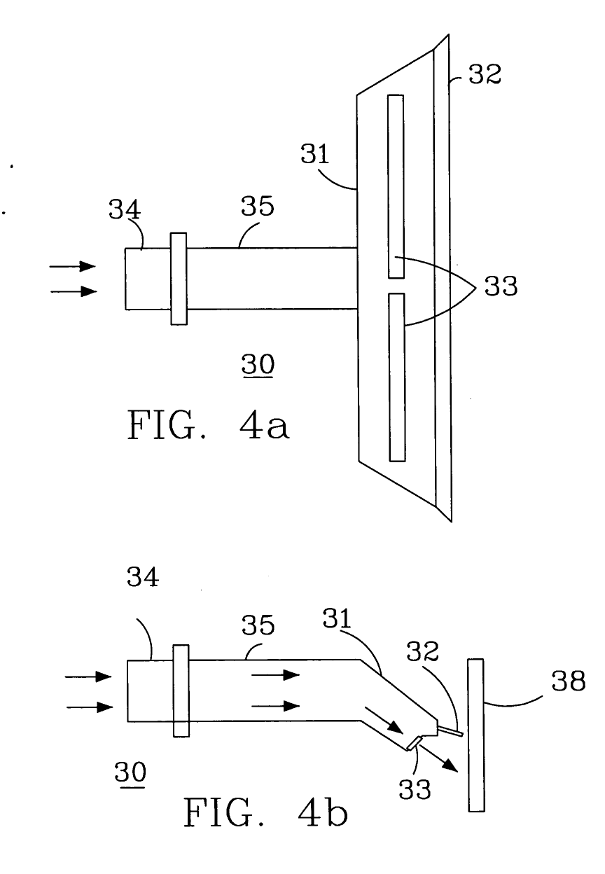

FIGS. 4a and 4b illustrate a squeegee device 30 for use with the blower/vacuum apparatus. Squeegee device 30 has a body 31 which includes a flexible brush strip 32 with openings 33 thereunder to permit an air flow under the part being brushed with strip 32. Air is directed though end 34 and channel 35 and out openings 33. Quick connect end 34 is connected to retractable hose 17a (FIG. 1)

FIG. 4b is a side view showing squeegee 30 brushing wall 38. Wall 38 may be the shower wall which is cleaned by squeegee 30. While brush strip 32 removes water from the wall, the air flow out openings 33 will dry the wall.

FIGS. 5a and 5b show a brush device for use with the blower/vacuum apparatus. FIG. 5a is a side view of brush 50. Brush 50 includes a body 51 with an end 52 that may be connected to the retractable hose 17a (FIG. 1). Brush bristles 53 extend outward from one side of body 51. There may be one or more rows of bristles 53, there being three illustrated in FIG. 5b. Also in FIG. 5b there are shown two openings 55 out of which air flows against the surface being brushed.

In use, brush 50 is a hair brush used to brush, dry and style a person's hair with air.

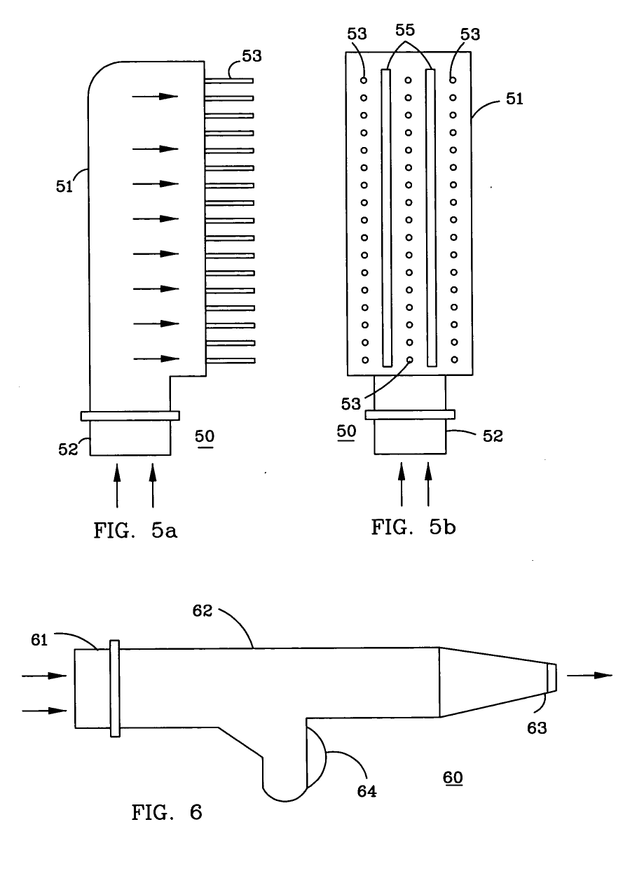

FIG. 6 shows an air gun 60 that may be used in drying the shower walls and the body. Air gun 60 has a quick disconnect end 61 that attaches to the retractable hose 17a (FIG. 1) on one end of body 62. Air exits air gun 60 at end 63. The air flow is controlled by trigger 64 that controls a valve (not illustrated) inside of air gun 60.

What is claimed:

1. A cleaning and drying apparatus for use with a shower, comprising:
a reversible fan/blower, in an enclosure, for directing air into and out of a shower compartment; and
a hose attachment device for attaching a plurality of cleaning devices through which air may be directed into and out of the shower compartment.

2. The cleaning and drying apparatus, according to claim 1, including an inflow air vent into the fan/blower enclosure and an exhaust vent for directing air out of said fan/blower enclosure.

3. The cleaning and drying apparatus, according to claim 2, wherein each of said inflow air vent and exhaust vent include valve devices, which may be opened or closed, for blocking the inflow and outflow of air from the fan/blower enclosure.

4. The cleaning and drying apparatus, according to claim 1, wherein said hose attachment is retractable.

5. The cleaning and drying apparatus, according to claim 1, including valve devices between the fan/blower enclosure and the shower.

6. The cleaning and drying apparatus, according to claim 5, wherein one valve controls the in/out flow of air directly between the shower and the fan/blower enclosure and another valve controls the air flow in/out between the fan/blower enclosure, through a hose attachment device and the shower.

7. The cleaning and drying apparatus, according to claim 6, wherein when one valve is open the other is closed.

8. The cleaning and drying apparatus, according to claim 1, wherein the plurality of cleaning devices include, but not limited to, squeegees and brushes.

9. The cleaning and drying apparatus, according to claim 8, wherein the cleaning brushes include a brush with a rotatably brush head.

10. A cleaning and drying apparatus for use with a shower, comprising:
a reversible fan/blower, in an enclosure, for directing air into and out of a shower compartment; and
a retractable hose attachment device for attaching a plurality of cleaning devices through which air may be directed into and out of the shower compartment.

11. The cleaning and drying apparatus, according to claim 10, including an inflow air vent into the fan/blower enclosure and an exhaust vent for directing air out of said fan/blower enclosure.

12. The cleaning and drying apparatus, according to claim 11, wherein each of said inflow air vent and exhaust vent include valve devices, which may be opened or closed, for blocking the inflow and out flow of air from the fan/blower enclosure.

13. The cleaning and drying apparatus, according to claim 10, including valve devices between the fan/blower enclosure and the shower.

14. The cleaning and drying apparatus, according to claim 13, wherein one valve controls the in/out flow of air directly between the shower and the fan/blower enclosure and another valve controls the air flow in/out between the fan/blower enclosure, through a hose attachment device and the shower.

15. The cleaning and drying apparatus, according to claim 14, wherein when one valve is open the other is closed.

16. The cleaning and drying apparatus, according to claim 10, wherein the plurality of cleaning devices include, but not limited to, squeegee and brushes.

17. The cleaning and drying apparatus, according to claim 16, wherein the cleaning brushes include a brush with a rotatably brush head.

18. The cleaning and drying apparatus, according to claim 1, including an air gun that attached to the retractable hose.
